(19) United States
(12) Patent Application Publication
(10) Pub. No.: US 2025/0035500 A1
(43) Pub. Date: Jan. 30, 2025

(54) RELATIVE PRESSURE MEASUREMENT RECORDER FOR DETERMINING A FIRST PRESSURE OF A MEDIUM

(71) Applicant: Endress+Hauser SE+Co. KG, Maulburg (DE)

(72) Inventors: Raimund Becher, Ehrenkirchen (DE); Kristine Bedner, Schopfheim (DE); Tobias Anders, Rheinfelden (DE)

(21) Appl. No.: 18/717,344

(22) PCT Filed: Nov. 28, 2022
(86) PCT No.: PCT/EP2022/083519

§ 371 Date: Jun. 6, 2024

(30) Foreign Application Priority Data
Dec. 15, 2021 (DE) 10 2021 133 183.8

(51) Int. Cl. G01L 13/02; G01L 19/06

(52) U.S. Cl. CPC G01L 13/026; G01L 19/0654

(57) ABSTRACT

A relative pressure measuring transducer includes a process adapter having a basic body, which includes a pressure sensitive process diaphragm, a first pressure transfer line and a pressure sensor. A pressure-sensitive reference pressure diaphragm is also provided. The basic body includes a second pressure transfer line, which leads the reference pressure from the reference pressure diaphragm to the pressure sensor and supplies a second area of the pressure sensor with the reference pressure. A housing adapter is embodied to surround the process adapter at the reference pressure diaphragm. The housing adapter is arranged in such a manner relative to the process adapter that in the region of the reference pressure diaphragm an intermediate space is formed between the housing adapter and the process adapter, and in the housing adapter there is a passageway, which connects the intermediate space with the environment of the relative pressure measuring transducer.

The invention relates to a relative pressure measuring transducer for determining a first pressure of a medium.

Known in pressure measuring technology are absolute pressure-, pressure difference- and relative, or gage, pressure measuring transducers. Absolute pressure measuring transducers determine the reigning pressure absolutely, i.e. with reference to vacuum, while difference measuring transducer determine the difference between two different pressures. In the case of relative pressure measuring transducers, the pressure to be measured is determined with reference to a reference pressure, wherein the atmospheric pressure reigning in the environment of the relative pressure measuring transducer serves as reference pressure.

Relative pressure measuring transducers have a pressure sensitive measuring element, the so-called pressure sensor, wherein the pressure of the medium to be measured acts on a first area of the measuring element. Acting on a second area of the measuring element is the atmospheric pressure, which is fed from the environment to the measuring element by means of a reference pressure supply. The measuring element deflects as a function of the relative pressure, which is formed by the difference between the pressure to be measured for the medium and the atmospheric pressure. This deflection is converted by means of an electronics into an electrical signal dependent on the relative pressure, which electrical signal is then available for additional processing or evaluation. The pressure sensor can be, among others, a capacitive pressure sensor or a piezoresistive pressure sensor. A number of such relative pressure measuring transducers are manufactured and sold by the Endress+Hauser group of companies.

Relative pressure measuring transducers are frequently applied in industrial processes involving their exposure to high temperature fluctuations and differences between process and environment. In the case of sudden cooling, the dew point of the air in an inner space of the relative pressure measuring transducer can be succeeded, this in turn leading to condensation of moisture on cold parts within the relative pressure measuring transducer. The moisture can get into the relative pressure measuring transducer especially through the opening of the reference pressure supply of the relative pressure measuring transducer to the environment for providing the reference pressure to the measuring element. Additionally, the relative pressure measuring transducers are frequently cleaned with water pressure, especially in the case of the pharma—and foods industries. In such cases, it is especially important that the water used for cleaning cannot penetrate into the interior of the relative pressure measuring transducer.

The pressure sensor and the electronics are, as a rule, very sensitive to moisture. Moisture can, for example, cause hysteresis effects at the pressure sensor. For a reliable determining of the pressure, it must, thus, be assured that no or only little moisture enters or condenses within the relative pressure measuring transducer. In the ideal case, the relative pressure measuring transducer and especially the reference pressure supply are so constructed that only dry air reaches the pressure sensor and the evaluation unit. As a rule, the reference pressure supply leads the ambient pressure to the pressure sensor through an opening frequently arranged in the housing of the relative pressure measuring transducer. Sometimes, a drying chamber with a moisture adsorbing material is arranged in the reference pressure supply between the opening and the pressure sensor for withdrawing moisture from the supplied environmental air and so dries the environmental air.

An object of the invention is to provide a relative pressure measuring transducer, into whose interior no moisture penetrates in case of cleaning with water pressure.

The object is achieved according to the invention by a relative pressure measuring transducer for determining a first pressure of a medium, comprising
a process adapter having a basic body,
   wherein, in a first, medium near, end region of the basic body, a pressure-sensitive process diaphragm is provided, wherein the basic body includes a first pressure transfer line, which is embodied to lead the first pressure of the medium from the process diaphragm to a pressure sensor arranged in a cavity of the basic body and to supply a first area of the pressure sensor with the first pressure of the medium,
   wherein in a second, medium far, region of the basic body a pressure-sensitive reference pressure diaphragm is provided, which is supplied with a reference pressure present in the environment of the relative pressure measuring transducer, wherein the basic body includes a second pressure transfer line, which is embodied to lead the reference pressure from the reference pressure diaphragm to the pressure sensor and to supply a second area of the pressure sensor with the reference pressure, and
a housing adapter, which is embodied to surround the process adapter at least in the region of the reference pressure diaphragm and is connected with the process adapter in at least one connection region,
   wherein the housing adapter is arranged in such a manner relative to the process adapter that in the region of the reference pressure diaphragm an intermediate space is formed between the housing adapter and the process adapter,
   wherein there is arranged in the housing adapter a passageway, which connects the intermediate space with the environment of the relative pressure measuring transducer.

According to the invention, the reference pressure is provided via the reference pressure diaphragm and transferred by means of the second pressure transfer line to the second area of the pressure sensor. Both the first pressure transfer line as well as also the second pressure transfer line are hydraulically embodied and, as a rule, filled with a silicone oil or a synthetic oil. Moisture from the environment of the relative pressure measuring transducer cannot enter into an interior of the relative pressure measuring transducer, since the reference pressure diaphragm prevents an entering of environmental air and the moisture associated therewith. Thus, no moisture gets to the pressure sensor.

The reference pressure diaphragm is, for example, a metal diaphragm. Also the process adapter and the housing adapter are, as a rule, made of metal. For preventing hysteresis effects of the pressure sensor, both the process adapter and the housing adapter are made of the same metal. However, also different metals can be used.

Environmental air can reach the reference pressure diaphragm by means of the passageway of the housing adapter. At the same time, the reference pressure diaphragm is protected from mechanical influences by the housing adapter surrounding it. An exposed, unprotected, reference pressure diaphragm would be greatly deformed in case of a cleaning with water pressure (for example, a water pressure of 100 bar is usual) and would, thus, be ruined. In order that the reference pressure diaphragm also in the case of varying pressures does not lie on the housing adapter, an intermediate space is provided between the reference pressure diaphragm, or process adapter and the housing adapter. Both the process diaphragm as well as also the reference pressure diaphragm have diaphragm beds, which the process diaphragm and the reference pressure diaphragm, in each case, contact, when a first pressure or a second pressure is present, which exceeds a predetermined limit value.

The relative pressure measuring transducer of the invention is thus composed essentially of two basic parts, the process adapter and the housing adapter, wherein three other components, the pressure sensor, the process diaphragm and the reference pressure diaphragm, are arranged in or on the two basic parts. Due to the small number of basic parts and components, the relative pressure measuring transducer of the invention is easy to manufacture.

In an embodiment, a moisture impermeable filter element is arranged in the passageway. The filter element prevents the entrance of moisture into the intermediate space and lets only the reference pressure in the form of environmental air to reach the reference pressure diaphragm.

Preferably, a moisture adsorbing material is arranged in the intermediate space. The moisture adsorbing material fills the intermediate space, at least partially, and takes up moisture from the environmental air present in the intermediate space.

Especially provided as moisture adsorbing material is a formed material comprising a polymer matrix and zeolite. The formed material is made of the polymer matrix and zeolite and can be embodied as a function of the embodiment of the intermediate space. The formed material can also be a sintered or composite material.

In a further development, the reference pressure diaphragm is arranged essentially perpendicularly to the process diaphragm on a lateral surface of the basic body of the process adapter. Such an arrangement of reference pressure diaphragm and process diaphragm enables a compact construction of the relative pressure measuring transducer.

In an embodiment, the process adapter has a first connection region, which is embodied for connection with a process connection. The process connection can be connected with the process adapter, for example, by means of a weld or a flange. As a rule, the process connection is selected as a function of the process conditions, such as, for example, the container, on which the relative pressure measuring transducer is to be mounted.

In an additional embodiment, the housing adapter has a second connection region, which is embodied for connection with a housing. The housing is, as a rule, embodied in such a manner that the components located in the housing are protected from mechanical influences. Moreover, the housing can offer other functionalities, such as e.g. a display provided on the housing.

Preferably, an electrically insulating bushing is arranged adjoining the second area of the pressure sensor supplied with the reference pressure, wherein the second pressure transfer line passes through the bushing. Electrical lines for the pressure sensor are led through the bushing.

Especially, the bushing is a glass-metal bushing.

Preferably, an orientation element is provided, which is arranged and embodied in such a manner that the bushing is orientable relative to the basic body by means of the orientation element. Since a section of the second pressure transfer line extends through the bushing, a predetermined orientation of the bushing needs to be assured in the case of connecting the bushing with the process connection. In the predetermined orientation of the bushing, the section of the second pressure transfer line extending through the bushing aligns with a section of the second pressure transfer line extending through the process adapter.

Especially, the orientation element is a pin. The pin is arranged, for example, partially in the process adapter and partially in the bushing, such that the bushing can only be inserted into the process adapter in a predetermined orientation.

The orientation element can, alternatively, be, for example, a nose, a projection, a shoulder or an edge, wherein a region adjoining the orientation element is embodied corresponding to the orientation element. The orientation element can also be arranged on the process adapter or on a filling element, the so-called displacement body, on which the pressure sensor is, as a rule, arranged.

In an embodiment, at least one electronics is arranged in a cavity of the housing adapter. The at least one electronics is, as a rule, electrically connected with the pressure sensor via the bushing.

In an additional embodiment, the process diaphragm and/or the reference pressure diaphragm are/is, in each case, connected with the basic body by means of a weld.

In a further development, the housing adapter is connected in the at least one connection region gas tightly with the process adapter. Gas tightness is achieved, for example, by means of at least one weld.

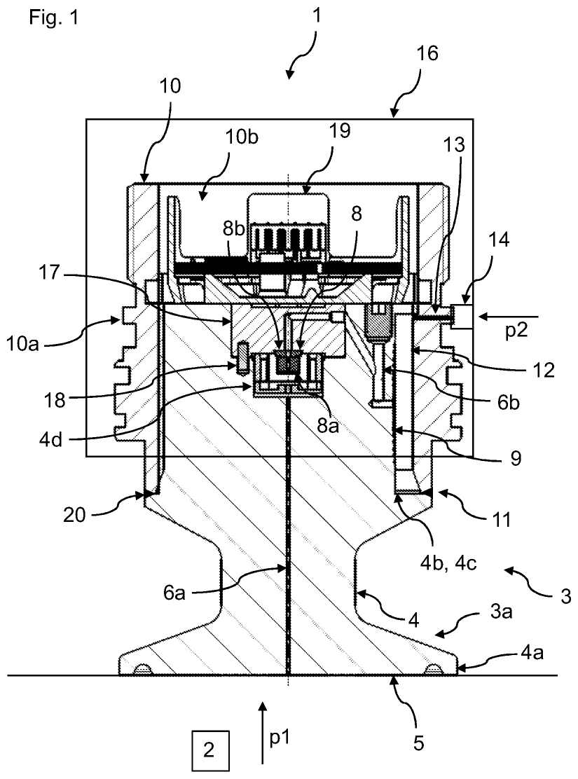

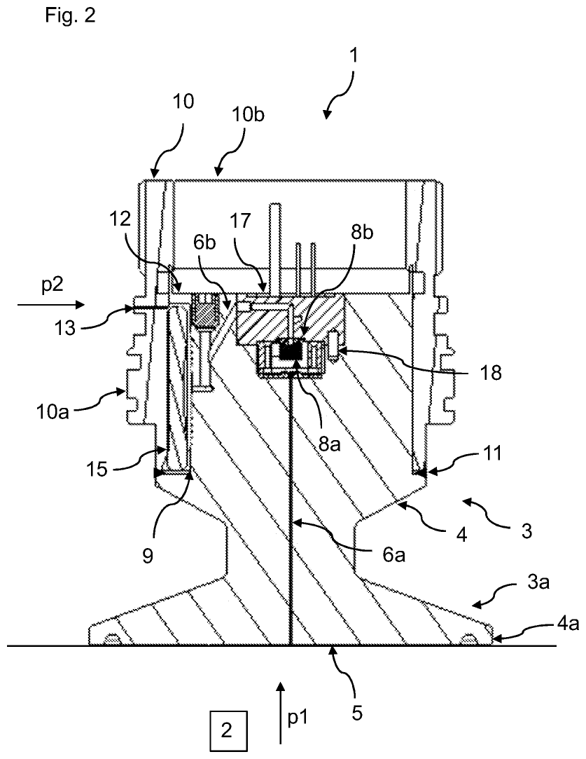

The invention will now be explained in greater detail based on the appended drawing, the FIGS. 1 and 2 of which show as follows:

FIG. 1a first embodiment of the relative pressure measuring transducer of the invention; and

FIG. 2 a second embodiment of the relative pressure measuring transducer of the invention.

A first embodiment of a relative pressure measuring transducer 1 of the invention is shown in FIG. 1. The relative pressure measuring transducer 1 has two basic parts, the process adapter 3 with a basic body 4 and the housing adapter 10. The two basic parts are connected together, especially gas tightly, in at least one connection region 11, for example, by a weld 20. The process adapter 3 includes an optional first connection region 3a, which is embodied for connection with a process connection (not shown), so that the relative pressure measuring transducer 1 can be located at a desired measuring point. The housing adapter 10 can, furthermore, have a second connection region 10a, which is embodied for connection with a housing 16 (schematically illustrated).

In a first, medium 2 near, end region of the basic body 4 of the process adapter 3, a pressure-sensitive process diaphragm 5 is arranged, which is supplied with a first pressure p1 of the medium 2. In a second, medium 2 far, region 4b of the basic body 4, a pressure-sensitive reference pressure diaphragm 9 is arranged, which is supplied with a reference pressure p2 present in the environment of the relative pressure measuring transducer 1. The process diaphragm 5 and/or the reference diaphragm 9 are connected with the basic body 4, for example, by means of a weld. The reference pressure diaphragm 9 is arranged, by way of example, on a lateral surface 4c of the basic body 4 essentially perpendicularly to the process diaphragm 5.

The first pressure p1 and the reference pressure p2 are led, respectively, by means of a first pressure transfer line 6a and a second pressure transfer line 6b from the process diaphragm 5 and from the reference pressure diaphragm 9 to the pressure sensor 8, such that the pressure sensor 8 is supplied at a first area 8a with the first pressure p1 and at a second area 8b opposite the first area 8a with the reference pressure p2. The pressure sensor 8 is arranged in a cavity 4d of the basic body 4. The first pressure transfer line 6a and the second pressure transfer line 6b are filled with pressure transfer liquid, for example, via separate filling openings or small filling tubes.

Provided adjoining the second area 8b of the pressure sensor 8 is an optional bushing 17, which is electrically insulating and serves for leading electrical lines to the pressure sensor 8. The electrical lines lead from the pressure sensor 8 through the bushing 17, for example, to at least one electronics 19, which is arranged optionally in a cavity 10b of the housing adapter 10. The second pressure transfer line 6b extends partially through the bushing 17, which is, for example, a glass-metal bushing. For sealing the second pressure transfer line 6b from the first pressure transfer line 6a, the second pressure transfer line 6b can be welded by means of a welding method in such a manner that the weld seam adjoins the second pressure transfer line 6b, without closing it.

In order to orient the section of the second pressure transfer line 6b extending through the process adapter 3 with the section of the second pressure transfer line 6b extending through the bushing 17 relative to one another, thus to align them relative to one another, an orientation element 18 can be provided. The orientation element 18 is, for example, a pin and is embodied and arranged in such a manner that the bushing 17 is orientable, i.e. assumes a predetermined orientation, relative to the basic body 4 by means of the orientation element 18.

The housing adapter 10 is embodied and arranged in such a manner that it surrounds the process adapter 3 at least in the region of the reference pressure diaphragm 9 and an intermediate space 12 is formed in the region of the reference pressure diaphragm 9 between the housing adapter 10 and the process adapter 3. In order that the reference pressure p2 can act as environmental air on the reference pressure diaphragm 9, a passageway 13 is arranged in the housing adapter 10, such that the intermediate space 12 is connected with the environment of the relative pressure measuring transducer 1.

For protection against penetration of moisture into the intermediate space 12, a moisture impermeable filter element 14 can be arranged in the region of the passageway 13. Additionally or alternatively, a moisture adsorbing material 15 shown in FIG. 2 can be arranged in the intermediate space 12. For example, provided as moisture adsorbing material 15 can be a formed body composed of at least zeolite and a polymer matrix.

### LIST OF REFERENCE CHARACTERS

1 relative pressure measuring transducer
2 medium
3 process adapter
3a first connection region
4 basic body
4a end region of the basic body
4b second region of the basic body
4c lateral surface
4d cavity of the basic body
5 process diaphragm
6a first pressure transfer line
6b second pressure transfer line
8 pressure sensor
8a first area
8b second area
9 reference pressure diaphragm
10 housing adapter
10a second connection region
10b cavity of the housing adapter
11 connection region
12 intermediate space
13 passageway
14 filter element
15 moisture adsorbing material
16 housing
17 bushing
18 orientation element
19 electronics
20 weld

1-14. (canceled)

15. Relative pressure measuring transducer for determining a first pressure of a medium, comprising
a process adapter having a basic body,
wherein, in a first, medium near, end region of the basic body, a pressure-sensitive process diaphragm is provided, wherein the basic body includes a first pressure transfer line, which is embodied to lead the first pressure of the medium from the process diaphragm to a pressure sensor arranged in a cavity of the basic body and to supply a first area of the pressure sensor with the first pressure of the medium,
wherein in a second, medium far, region of the basic body, a pressure-sensitive reference pressure diaphragm is provided, which is supplied with a reference pressure present in the environment of the relative pressure measuring transducer wherein the basic body includes a second pressure transfer line, which is embodied to lead the reference pressure from the reference pressure diaphragm to the pressure sensor and to supply a second area of the pressure sensor with the reference pressure, and
a housing adapter, which is embodied to surround the process adapter at least in the region of the reference pressure diaphragm and is connected with the process adapter in at least one connection region,
wherein the housing adapter is arranged in such a manner relative to the process adapter that in the region of the reference pressure diaphragm an intermediate space is formed between the housing adapter and the process adapter,
wherein there is arranged in the housing adapter a passageway, which connects the intermediate space with the environment of the relative pressure measuring transducer.

16. The relative pressure measuring transducer as claimed in claim 15,
wherein a moisture impermeable filter element is arranged in the region of the passageway.

17. The relative pressure measuring transducer as claimed in claim 15, wherein a moisture adsorbing material is arranged in the intermediate space.

18. The relative pressure measuring transducer as claimed in claim 17,
wherein provided as moisture adsorbing material is a formed material comprising a polymer matrix and zeolite.

19. The relative pressure measuring transducer as claimed in 15, wherein the reference pressure diaphragm is arranged essentially perpendicularly to the process diaphragm on a lateral surface of the basic body of the process adapter.

20. The relative pressure measuring transducer as claimed in claim 15, wherein the process adapter has a first connection region, which is embodied for connection with a process connection.

21. The relative pressure measuring transducer as claimed in 15, wherein the housing adapter has a second connection region, which is embodied for connection with a housing.

22. The relative pressure measuring transducer as claimed in claim 15, wherein an electrically insulating bushing is arranged adjoining the second area of the pressure sensor supplied with the reference pressure, wherein the second pressure transfer line passes through the bushing.

23. The relative pressure measuring transducer as claimed in claim 22, wherein the bushing is a glass-metal bushing.

24. The relative pressure measuring transducer as claimed in 22, wherein an orientation element is provided, which is arranged and embodied in such a manner that the bushing is orientable relative to the basic body by means of the orientation element.

25. The relative pressure measuring transducer as claimed in 24, wherein the orientation element is a pin.

26. The relative pressure measuring transducer as claimed in 15, wherein at least one electronics is arranged in a cavity of the housing adapter.

27. The relative pressure measuring transducer as claimed in claim 15, wherein the process diaphragm and/or the reference pressure diaphragm are/is connected with the basic body by means of a weld.

28. The relative pressure measuring transducer as claimed in claim 15, wherein the housing adapter is connected in the at least one connection region gas tightly with the process adapter.
